(19) United States
(12) Patent Application Publication
(10) Pub. No.: US 2026/0177322 A1
(43) Pub. Date: Jun. 25, 2026

(54) METHOD AND SYSTEM FOR DETECTING CROSS-SECTIONAL TEMPERATURE FIELD OF FURNACE WITH SINGLE INFRARED PROBE

(71) Applicants: JIANGSU HANGUANG INTELLIGENT TECHNOLOGY CO., LTD., Xuzhou (CN); XIHUA UNIVERSITY, Chengdu (CN)

(72) Inventors: Yuanke ZHOU, Xuzhou (CN); Yuansi ZHOU, Xuzhou (CN); Huaichun ZHOU, Chengdu (CN)

(73) Assignees: JIANGSU HANGUANG INTELLIGENT TECHNOLOGY CO., LTD., Xuzhou (CN); XIHUA UNIVERSITY, Chengdu (CN)

(21) Appl. No.: 19/426,135

(22) Filed: Dec. 19, 2025

(30) Foreign Application Priority Data
Dec. 20, 2024 (CN) 202411888084.7

(51) Int. Cl. F27D 21/00; G01J 5/00; G01J 5/28

(52) U.S. Cl. CPC F27D 21/0014; G01J 5/0044; G01J 5/28

(57) ABSTRACT

The provided is a method and system for detecting a cross-sectional temperature field of a furnace with a single infrared probe. The method includes: acquiring environmental information of a preset simulated detection space and a periphery of the furnace; collecting a first detected temperature at a first preset point, and determining a first distance between a first preset position and the first preset point; collecting a second detected temperature at the first preset point; determining an error relationship function; collecting cross-sectional temperature data of the furnace at a plurality of second preset points in a cross-section of the furnace, and determining coordinate information of the plurality of second preset points in a furnace coordinate system; determining a detection score of the cross-sectional temperature field of the furnace; and generating a detection report of the cross-sectional temperature field of the furnace.

### CROSS-REFERENCE TO THE RELATED APPLICATIONS

This application is based upon and claims priority to Chinese Patent Application No. 202411888084.7, filed on Dec. 20, 2024, the entire contents of which are incorporated herein by reference.

### TECHNICAL FIELD

The present disclosure relates to the technical field of temperature detection, and in particular, to a method and system for detecting a cross-sectional temperature field of a furnace with a single infrared probe.

### BACKGROUND

In related technologies, Chinese patent CNI16086614B discloses a method for visualized monitoring of a cross-sectional temperature field and a radiation characteristic of a boiler furnace by combining a radiation image and a spectrum, which belongs to the field of thermal radiation temperature detection and can adapt to harsh measurement conditions. An image detector can be directly inserted into a flame observation hole of a boiler to acquire flame image data. When such a detection system is applied in a power plant boiler, no additional drilling is required, and there is no risk of reducing furnace wall strength of the boiler due to the drilling. Based on a cross-sectional temperature field measured by the detection system for the furnace, a combustion status inside the furnace can be accurately determined. This can provide accurate and effective guidance for boiler combustion adjustment, reduce temperature deviation in each combustion zone of the boiler, and maintain stable operation of the boiler, thereby improving combustion efficiency of the boiler and reducing pollutant emissions.

Chinese patent CN103808412B discloses a temperature measurement device and method for a workpiece in a furnace, which are mainly used for online measurement of a surface temperature field of a workpiece in a furnace of an industrial boiler in the thermal processing field. The temperature measurement device for a workpiece in a furnace in this solution includes components such as an infrared endoscope lens group with a cooling protection sleeve, a high-temperature flue gas filter, an infrared thermal imaging probe, an automatic rotation and advancement/retraction mechanism for the lens group, an infrared thermal imaging temperature measurement host, a monitoring and displaying device, and a contact-type workpiece surface temperature thermometer, which together form an infrared thermal imaging temperature measurement system and device for the surface temperature field of the workpiece in the furnace and a temperature measurement method thereof. In this solution, the infrared thermal imaging lens group is equipped with the high-temperature flue gas filter to effectively filter out a shielding effect of high-temperature flue gas on a surface temperature of the workpiece in the furnace. Through an error correction algorithm of a thermal pixel temperature system, a system error is effectively eliminated, thereby improving accuracy of temperature measurement.

Based on the above related technologies, the system error can be effectively eliminated through the error correction algorithm of the thermal pixel temperature system, thereby improving the temperature measurement accuracy. However, the related technologies do not consider impacts of other environmental factors (such as humidity, wind force, and measurement distance) on error of the temperature measurements. That is, it is difficult for the related technologies to consider impacts of real-time environmental factors on temperature measurements, thereby making it difficult to ensure accuracy of detection results of the cross-sectional temperature field of the furnace.

The information disclosed in the background section of the present disclosure is only intended to deepen the understanding of the general background of the present disclosure, and should not be regarded as an acknowledgement or any form of suggestion that this information constitutes the prior art commonly known to those skilled in the art.

### SUMMARY

The present disclosure provides a method and system for detecting a cross-sectional temperature field of a furnace with a single infrared probe, which can solve the technical problem in the related technologies that it is difficult to consider impacts of real-time environmental factors on temperature measurement, thereby failing to ensure accuracy of a detection result of the cross-sectional temperature field of the furnace.

According to a first aspect of the present disclosure, a method for detecting a cross-sectional temperature field of a furnace with a single infrared probe is provided, including:
acquiring environmental information of a preset simulated detection space and a periphery of the furnace through a combination of sensors disposed around the furnace, where the environmental information includes temperature information, humidity information, and wind force information;
at a plurality of time points in a simulated detection cycle, collecting a first detected temperature at a first preset point by using a single infrared probe disposed at a first preset position, and determining a first distance between the first preset position and the first preset point;
collecting a second detected temperature at the first preset point by using a temperature sensor disposed at the first preset point;
determining an error relationship function based on the first distance, the first detected temperature, the second detected temperature, and the environmental information;
at the plurality of time points in the detection cycle, collecting cross-sectional temperature data of the furnace at a plurality of second preset points in a cross-section of the furnace by using second single infrared probes disposed at a plurality of second preset positions in the furnace, and determining coordinate information of the plurality of second preset points in a furnace coordinate system, where the furnace coordinate system is a coordinate system established based on a centroid of the cross-section of the furnace;
determining a detection score of the cross-sectional temperature field of the furnace based on the cross-sectional temperature data of the furnace and the coordinate information; and

generating a detection report of the cross-sectional temperature field of the furnace based on the detection score of the cross-sectional temperature field of the furnace.

According to a second aspect of the present disclosure, a system for detecting a cross-sectional temperature field of a furnace with a single infrared probe is provided, including:

an environmental information module configured to acquire environmental information of a preset simulated detection space and a periphery of the furnace through a combination of sensors disposed around the furnace, where the environmental information includes temperature information, humidity information, and wind force information;
a simulation detection module configured to: at a plurality of time points in a simulated detection cycle, collect a first detected temperature at a first preset point by using a single infrared probe disposed at a first preset position, and determine a first distance between the first preset position and the first preset point;
a simulation information module configured to collect a second detected temperature at the first preset point by using a temperature sensor disposed at the first preset point;
a relationship function module configured to determine an error relationship function based on the first distance, the first detected temperature, the second detected temperature, and the environmental information;
a detection information module configured to: at the plurality of time points in the detection cycle, collect cross-sectional temperature data of the furnace at a plurality of second preset points in a cross-section of the furnace by using second single infrared probes disposed at a plurality of second preset positions in the furnace, and determine coordinate information of the plurality of second preset points in a furnace coordinate system, where the furnace coordinate system is a coordinate system established based on a centroid of the cross-section of the furnace;
a detection score module configured to determine a detection score of the cross-sectional temperature field of the furnace based on the cross-sectional temperature data of the furnace and the coordinate information; and
a detection report module configured to generate a detection report of the cross-sectional temperature field of the furnace based on the detection score of the cross-sectional temperature field of the furnace.

Technical effects: According to the present disclosure, a relationship between a temperature detection error and each of temperature information, humidity information, a detection distance, and wind force information can be accurately analyzed. Furthermore, based on the relationship, accuracy of detecting a cross-sectional temperature field of a furnace is improved. The cross-sectional temperature field of the furnace is detected and analyzed based on cross-sectional temperature data of the furnace and coordinate information at various second preset points, thereby enhancing accuracy of a detection result of the cross-sectional temperature field of the furnace. An error relationship function can be determined based on a first emissivity, a first camera emissivity, a first distance, a first detected temperature, a second detected temperature, and environmental information, such that a relationship between the temperature detection error and each of an environmental factor, a camera emissivity, and the detection distance is accurately described, thereby improving accuracy of the error relationship function. Actual cross-sectional temperature data of the furnace is determined based on second camera emissivities, second emissivities, a second distance, the environmental information, the cross-sectional temperature data of the furnace, and the error relationship function. This can improve accuracy and objectivity of the actual cross-sectional temperature data of the furnace, providing a data foundation for subsequent detection of the cross-sectional temperature field of the furnace. A detection score of the cross-sectional temperature field of the furnace can be determined based on a first standard deviation, a second standard deviation, a temperature change rate distribution function, and a temperature distribution function. In a calculation process, the cross-sectional temperature field of the furnace can be separately detected and analyzed from a plurality of aspects, including an overall distribution that is of the cross-sectional temperature field of the furnace and determined based on a temperature, an overall distribution that is of the cross-sectional temperature field of the furnace and determined based on a temperature change rate, and whether there is a high-temperature condition in a cross-section of the furnace. This enhances comprehensiveness and accuracy of the detection score of the cross-sectional temperature field of the furnace.

It should be understood that the foregoing general description and the following detailed description are only exemplary and explanatory, and should not be construed as a limitation on the present disclosure. Based on the following detailed descriptions of exemplary embodiments with reference to the accompanying drawings, other features and aspects of the present disclosure will become clearer.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show merely some embodiments of the present disclosure, and those of ordinary skill in the art may still derive other embodiments from these accompanying drawings without creative efforts.

FIG. 1 is a schematic flowchart of a method for detecting a cross-sectional temperature field of a furnace with a single infrared probe according to an embodiment of the present disclosure; and

FIG. 2 is schematic diagram of a system for detecting a cross-sectional temperature field of a furnace with a single infrared probe according to an embodiment of the present disclosure.

### DETAILED DESCRIPTION OF THE EMBODIMENTS

To make the objectives, technical solutions, and advantages of the embodiments of the present disclosure clearer, the technical solutions in the embodiments of the present disclosure will be described below clearly and completely with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts shall fall within the protection scope of the present disclosure.

The technical solution of the present disclosure will be described in detail below with reference to specific embodiments. The following specific embodiments may be combined with each other, and the same or similar concepts or processes may not be repeatedly described in some embodiments.

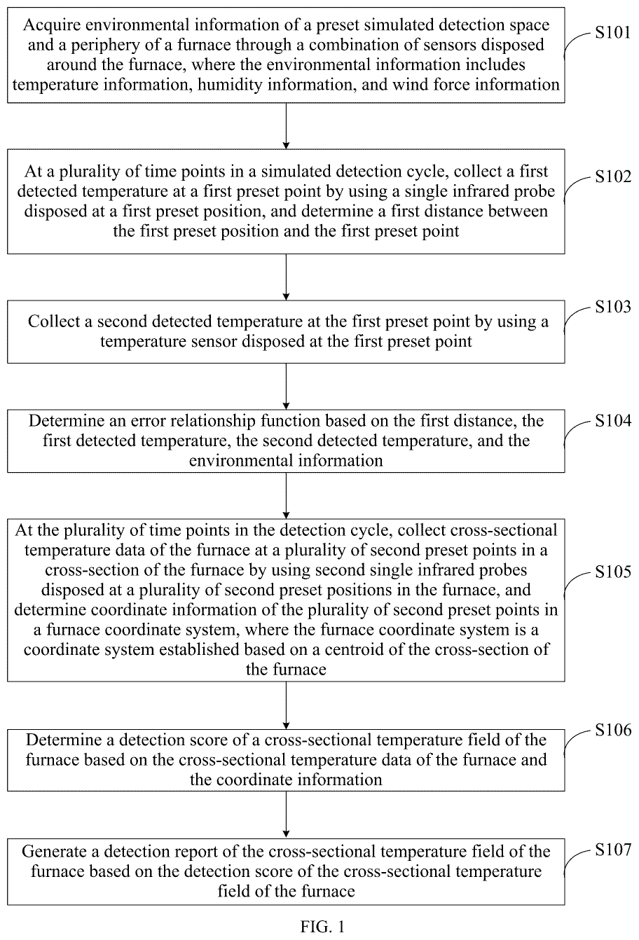

FIG. 1 is a schematic flowchart of a method for detecting a cross-sectional temperature field of a furnace with a single infrared probe according to an embodiment of the present disclosure. The method includes the following steps:

In step S101, environmental information of a preset simulated detection space and a periphery of the furnace is acquired through a combination of sensors disposed around the furnace, where the environmental information includes temperature information, humidity information, and wind force information.

In step S102, at a plurality of time points in a simulated detection cycle, a first detected temperature at a first preset point is collected by using a single infrared probe disposed at a first preset position, and a first distance between the first preset position and the first preset point is determined.

In step S103, a second detected temperature at the first preset point is collected by using a temperature sensor disposed at the first preset point.

In step S104, an error relationship function is determined based on the first distance, the first detected temperature, the second detected temperature, and the environmental information.

In step S105, at the plurality of time points in the detection cycle, cross-sectional temperature data of the furnace at a plurality of second preset points in a cross-section of the furnace is collected by using second single infrared probes disposed at a plurality of second preset positions in the furnace, and coordinate information of the plurality of second preset points in a furnace coordinate system is determined, where the furnace coordinate system is a coordinate system established based on a centroid of the cross-section of the furnace.

In step S106, a detection score of the cross-sectional temperature field of the furnace is determined based on the cross-sectional temperature data of the furnace and the coordinate information.

In step S107, a detection report of the cross-sectional temperature field of the furnace is generated based on the detection score of the cross-sectional temperature field of the furnace.

According to the method for detecting a cross-sectional temperature field of a furnace with a single infrared probe in this embodiment of the present disclosure, a relationship between a temperature detection error and each of temperature information, humidity information, a detection distance, and wind force information can be accurately analyzed.

Furthermore, based on the relationship, accuracy of detecting the cross-sectional temperature field of the furnace is improved. The cross-sectional temperature field of the furnace is detected and analyzed based on cross-sectional temperature data of the furnace and coordinate information at various second preset points, thereby enhancing accuracy of a detection result of the cross-sectional temperature field of the furnace.

According to an embodiment of the present disclosure, in the step S101, the environmental information of the preset simulated detection space and the periphery of the furnace is acquired through the combination of sensors disposed around the furnace, where the environmental information includes the temperature information, the humidity information, and the wind force information.

For example, a temperature, a humidity, and a wind force in the preset simulated detection space can be artificially adjusted to simulate temperature measurement of the single infrared probe under different environmental conditions. The temperature information, the humidity information, and the wind force information of the periphery of the furnace are acquired through a temperature sensor, a humidity sensor, and a wind force sensor that are disposed around the furnace.

According to an embodiment of the present disclosure, in the step S102, at the plurality of time points in the simulated detection cycle, the first detected temperature at the first preset point is collected by using the single infrared probe disposed at the first preset position, and the first distance between the first preset position and the first preset point is determined.

For example, during operation of the furnace, it is impossible to directly use the temperature sensor to detect a temperature at each point of the cross-section of the furnace, and the single infrared probe will introduce an error during the temperature measurement.

Therefore, prior to detecting the cross-sectional temperature field of the furnace, a simulated detection experiment is first conducted to determine impacts of various external factors on a temperature measurement result of the single infrared probe. In the simulated detection experiment, a preset point in the preset simulated detection space is determined as the first preset point, which can fully reflect an environmental change in the preset simulated detection space. The single infrared probe is disposed at the first preset position to detect the first detected temperature at the first preset point. The first preset point is a fixed point, while the first preset position is a movable point. The first distance between the first preset position and the first preset point increases uniformly as the simulated detection cycle progresses.

According to an embodiment of the present disclosure, in the step S103, the second detected temperature at the first preset point is collected by using the temperature sensor disposed at the first preset point.

For example, the temperature sensor is disposed at the first preset point to collect an actual temperature, namely the second detected temperature, at the first preset point.

According to an embodiment of the present disclosure, in the step S104, the error relationship function is determined based on the first distance, the first detected temperature, the second detected temperature, and the environmental information.

According to an embodiment of the present disclosure, the step S104 includes the following substeps:

A first emissivity of a material at the first preset point is acquired.

A first camera emissivity of the single infrared probe at the first preset position is acquired.

The error relationship function is determined based on the first emissivity, the first camera emissivity, the first distance, the first detected temperature, the second detected temperature, and the environmental information.

For example, an emissivity of a material is a ratio of energy radiated from a surface of the material to energy radiated from a blackbody at a same temperature, which is an important parameter for measuring thermal radiation performance of the material. Different object materials have different emissivities. The first emissivity of the material at the first preset point is obtained through a detection instrument (for example, an infrared radiometer). The preset first camera emissivity of the single infrared probe at the first preset position is acquired.

The single infrared probe is equipped with a camera capable of detecting infrared radiation of an object. The first camera emissivity is an artificially preset parameter based on a material of a measured target, and has a corresponding relationship with the material of the measured target.

If this emissivity is incorrectly set, an error will be caused to a measurement result, and the first camera emissivity is stored in a memory of the camera. An error between the first detected temperature and the second detected temperature is related to an emissivity, a detection distance, and a surrounding environment to a certain extent. Based on correlation of the above data, a relationship function between the error between the first detected temperature and the second detected temperature and each of the first emissivity, the first camera emissivity, the first distance, and the environmental information can be determined.

According to an embodiment of the present disclosure, that the error relationship function is determined based on the first emissivity, the first camera emissivity, the first distance, the first detected temperature, the second detected temperature, and the environmental information includes: A to-be-fitted equation of the error relationship function is determined according to a formula (1):

$${DT}_{1 , i} - {DT}_{2 , i} = if \{ {Em}_{1} > {Em}_{c 1} , \frac{{Em}_{c 1}}{{α}_{9} ( {Em}_{1} - {Em}_{c 1} ) + {α}_{10} {Em}_{c 1}} , if \{ {Em}_{1} = {Em}_{c 1} , 1 , {α}_{9} \frac{{Em}_{c 1} - {Em}_{1}}{{Em}_{1}} + {α}_{10} \} \} \times \frac{( {α}_{3} {ET}_{i} + {α}_{4} )}{( {α}_{1} {Di}_{1 , i} + {α}_{2} ) ( {α}_{5} {EH}_{i} + {α}_{6} ) ( {α}_{7} {EF}_{i} + {α}_{8} )} \qquad ( 1 )$$

where if represents a conditional function, DT_{1,i} represents a first detected temperature at the first preset point at an i^{th} time point in the simulated detection cycle, DT_{2,i} represents a second detected temperature at the first preset point at the i^{th} time point in the simulated detection cycle, Em₁ represents the first emissivity of the material at the first preset point, Em_{c1} represents the first camera emissivity of the single infrared probe at the first preset position, Di_{1,i} represents a first distance between the first preset position and the first preset point at the i* time point in the simulated detection cycle, ETᵢ represents temperature information of the preset simulated detection space at the i^{th} time point in the simulated detection cycle, EHᵢ represents humidity information of the preset simulated detection space at the i^{th} time point in the simulated detection cycle, EFᵢ represents wind force information of the preset simulated detection space at the i^{th} time point in the simulated detection cycle, and α₁, α₂, α₃, α₄, α₅, α₆, α₇, α₈, α₉, and α₁₀ represent to-be-fitted coefficients.

The to-be-fitted coefficients are solved based on the first emissivity, the first camera emissivity, the first distance, the first detected temperature, the second detected temperature, and the environmental information, and solved values of the to-be-fitted coefficients are obtained.

The error relationship function is determined based on the solved values of the to-be-fitted coefficients and the to-be-fitted equation.

According to an embodiment of the present disclosure, the single infrared probe introduces a measurement error due to impacts of external factors during temperature detection. DT_{1,i}−DT_{2,i} represents a difference between the first detected temperature and the second detected temperature at the i^{th} time point in the simulated detection cycle, which indicates an error value of the temperature detection.

According to an embodiment of the present disclosure, in the formula (1), the following two situations can be expressed in a form of the conditional function. When Em₁>Em_{c1} is met, the first emissivity is greater than the first camera emissivity. If the emissivity of the material at the first preset point is greater than that of the single infrared probe, the single infrared probe may underestimate a true temperature at the first preset point. As a result, a value of the first detected temperature DT_{1,i} is too small, and consequently a value of the DT_{1,i}−DT_{2,i} is small. A value of the conditional function is

$$\frac{{Em}_{c 1}}{{α}_{9} ( {Em}_{1} - {Em}_{c 1} ) + {α}_{10} {Em}_{c 1}} ,$$

$$where$$

$$\frac{{Em}_{c 1}}{{α}_{9} ( {Em}_{1} - {Em}_{c 1} ) + {α}_{10} {Em}_{c 1}} = \frac{1}{{α}_{9} \frac{{Em}_{1} - {Em}_{c 1}}{{Em}_{c 1}} + {α}_{10}} , and \frac{{Em}_{1} - {Em}_{c 1}}{{Em}_{c 1}}$$

represents a relative difference between the first emissivity and the first camera emissivity. A larger ratio indicates a higher first emissivity, leading to a smaller value of the first detected temperature DT_{1,i} and consequently a smaller value of the

$${DT}_{1 , i} - {DT}_{2 , i} \cdot \frac{{Em}_{c 1}}{{α}_{9} ( {Em}_{1} - {Em}_{c 1} ) + {α}_{10} {Em}_{c 1}}$$

indicates that the relative difference between the first emissivity and the first camera emissivity has a negative correlation with the temperature detection error. When Em₁>Em_{c1} is not met, the value of the conditional function is a value of inner conditional function

$$if \{ {Em}_{1} = {Em}_{c 1} , 1 , {α}_{9} \frac{{Em}_{c 1} - {Em}_{1}}{{Em}_{1}} + {α}_{10} \} .$$

According to an embodiment of the present disclosure, the value of the inner conditional function

$$if \{ {Em}_{1} = {Em}_{c 1} , 1 , {α}_{9} \frac{{Em}_{c 1} - {Em}_{1}}{{Em}_{1}} + {α}_{10} \}$$

includes the following two situations. When Em₁=Em_{c1} is met, the first emissivity is equal to the first camera emissivity, an error between a temperature detected by the single infrared probe and the true temperature at the first preset point is small, and the value of the conditional function is 1. When Em₁=Em_{c1} is not met, the first emissivity is less than the first camera emissivity. If the emissivity of the material at the first preset point is less than that of the single infrared probe, the single infrared probe may overestimate a true temperature of the object. As a result, the value of the first detected temperature DT_{1,i} is too large, and consequently the value of the DT_{1,i}−DT_{2,i} is large. The value of the conditional function is

$${α}_{9} \frac{{Em}_{c 1} - {Em}_{1}}{{Em}_{1}} + {α}_{10} , where \frac{{Em}_{c 1} - {Em}_{1}}{{Em}_{1}}$$

represents a relative difference between the first camera emissivity and the first emissivity. A larger ratio leads to a larger value of the first detected temperature DT_{1,i} and consequently a larger value of the

$${DT}_{1 , i} - {DT}_{2 , i} \cdot {α}_{9} \frac{{Em}_{c 1} - {Em}_{1}}{{Em}_{1}} + {α}_{10}$$

indicates that the relative difference between the first camera emissivity and the first emissivity has a positive correlation with the temperature detection error. The conditional function

$$if \{ {Em}_{1} > {Em}_{c 1} , \frac{{Em}_{c 1}}{{α}_{9} ( {Em}_{1} - {Em}_{c 1} ) + {α}_{10} {Em}_{c 1}} , if \{ {Em}_{1} = {Em}_{c 1} , 1 , {α}_{9} \frac{{Em}_{c 1} - {Em}_{1}}{{Em}_{1}} + {α}_{10} \} \}$$

represents a relationship between an intrinsic factor (emissivity) of the single infrared probe and the temperature detection error.

According to an embodiment of the present disclosure, in the

$$\frac{( {α}_{3} {ET}_{i} + {α}_{4} )}{( {α}_{1} {Di}_{1 , i} + {α}_{2} ) ( {α}_{5} {EH}_{i} + {α}_{6} ) ( {α}_{7} {EF}_{i} + {α}_{8} )} , ( {α}_{3} {ET}_{i} + {α}_{4} )$$

indicates that the temperature information at the i^{th} time point in the simulated detection cycle has a positive correlation with a magnitude of the temperature detection error. A higher temperature of a surrounding environment of the furnace leads to a greater value of the first detected temperature DT_{1,i} detected by the single infrared probe at the first preset point and a larger magnitude of the temperature detection error

$${DT}_{1 , i} - {DT}_{2 , i} \cdot \frac{1}{( {α}_{1} {Di}_{1 , i} + {α}_{2} )}$$

indicates that the first distance has a negative correlation with the magnitude of the temperature detection error. A longer first distance leads to a stronger attenuation effect of atmosphere on the infrared radiation, resulting in a decrease in target radiation energy detected by the single infrared probe, a smaller value of the first detected temperature DT_{1,i}, and a smaller magnitude of the temperature detection error

$${DT}_{1 , i} - {DT}_{2 , i} \cdot \frac{1}{( {α}_{5} {EH}_{i} + {α}_{6} )}$$

indicates that the humidity information at the i^{th} time point in the simulated detection cycle has a negative correlation with the magnitude of the temperature detection error. A higher humidity leads to more water in air, and the water absorbs the infrared radiation, resulting in a decrease in the target radiation energy detected by the single infrared probe, a smaller value of the first detected temperature DT_{1,i}, and a smaller magnitude of the temperature detection error

$${DT}_{1 , i} - {DT}_{2 , i} \cdot \frac{1}{( {α}_{7} {EF}_{i} + {α}_{8} )}$$

indicates that the wind force information at the i^{th} time point in the simulated detection cycle has a negative correlation with the magnitude of the temperature detection error. A greater wind force leads to quicker dissipation of heat of a measured object by wind, resulting in a smaller value of the first detection temperature DT_{1,i} detected by the single infrared probe, and a smaller magnitude of the temperature detection errorDT_{1,i}−DT_{2,i}. The

$$\frac{( {α}_{3} {ET}_{i} + {α}_{4} )}{( {α}_{1} {Di}_{1 , i} + {α}_{2} ) ( {α}_{5} {EH}_{i} + {α}_{6} ) ( {α}_{7} {EF}_{i} + {α}_{8} )}$$

represents a relationship between an external environmental factor and the temperature detection error.

According to an embodiment of the present disclosure, the plurality of to-be-fitted coefficients can be solved by fitting a plurality of parameters involved in an undetermined coefficient equation, namely the first emissivity, the first camera emissivity, the first distance, the first detected temperature, the second detected temperature, and the environmental information. There are ten to-be-fitted coefficients, namely the α₁, the α₂, the α₃, the α₄, the α₅, the α₆, the α₇, the α₅, the ag, and the α₁₀. These ten to-be-fitted coefficients are solved to obtain solved values of these ten to-be-fitted coefficients, and the obtained solved values of these ten to-be-fitted coefficients are substituted into the to-be-fitted equation to determine the error relationship function.

In this way, the error relationship function can be determined based on the first emissivity, the first camera emissivity, the first distance, the first detected temperature, the second detected temperature, and the environmental information, such that a relationship between the temperature detection error and each of an environmental factor, a camera emissivity, and the detection distance is accurately described, thereby improving accuracy of the error relationship function.

According to an embodiment of the present disclosure, in the step S105, at the plurality of time points in the detection cycle, the cross-sectional temperature data of the furnace at the plurality of second preset points in the cross-section of the furnace is collected by using the second single infrared probes disposed at the plurality of second preset positions in the furnace, and the coordinate information of the plurality of second preset points in the furnace coordinate system is determined, where the furnace coordinate system is the coordinate system established based on the centroid of the cross-section of the furnace.

For example, a plurality of single infrared probes are installed at appropriate positions in the furnace, namely at the plurality of second preset positions, so as to collect temperature information of the cross-section of the furnace. The plurality of second preset positions are not directly scoured by flame inside the furnace, so as to avoid damaging the probes or affecting measurement accuracy. The plurality of second preset points are evenly distributed across the cross-section of the furnace. Through the single infrared probes disposed at the plurality of second preset positions corresponding to the plurality of second preset points, the cross-sectional temperature data of the furnace at the plurality of second preset points is collected.

According to an embodiment of the present disclosure, in the step S106, the detection score of the cross-sectional temperature field of the furnace is determined based on the cross-sectional temperature data of the furnace and the coordinate information.

According to an embodiment of the present disclosure, the step S106 includes the following substeps:

Camera coordinate information of the plurality of second preset positions in the furnace coordinate system is acquired.

A second distance is determined based on the camera coordinate information and the coordinate information.

Second camera emissivities of the second single infrared probes disposed at the plurality of second preset positions in the furnace are acquired.

Second emissivities of materials at the plurality of second preset points are acquired.

Actual cross-sectional temperature data of the furnace is determined based on the second camera emissivities, the second emissivities, the second distance, the environmental information, the cross-sectional temperature data of the furnace, and the error relationship function.

The detection score of the cross-sectional temperature field of the furnace is determined based on the actual cross-sectional temperature data of the furnace and the coordinate information.

For example, based on camera coordinate information at a second preset position and coordinate information of a corresponding second preset point, a second distance between the second preset position and the second preset point is determined. The second emissivities set for the second single infrared probes at the plurality of second preset positions are determined.

The second emissivities of the materials in the cross-section of the furnace are detected by the detection instrument. The actual cross-sectional temperature data of the furnace at the plurality of second preset points in the cross-section of the furnace is calculated based on the second camera emissivities, the second emissivities, the second distance, the environmental information, the cross-sectional temperature data of the furnace, and the error relationship function. The cross-sectional temperature field of the furnace is detected and analyzed based on the actual cross-sectional temperature data of the furnace and the coordinate information of the plurality of second preset points to determine the detection score of the cross-sectional temperature field of the furnace.

According to an embodiment of the present disclosure, that actual cross-sectional temperature data of the furnace is determined based on the second camera emissivities, the second emissivities, the second distance, the environmental information, the cross-sectional temperature data of the furnace, and the error relationship function includes: actual cross-sectional temperature data FFT_{k,j} of the furnace at a k^{th} second preset point at a j^{th} time point in the detection cycle is determined according to a formula (2):

$${FT}_{k , j} - {FFT}_{k , j} = if \{ {Em}_{2 , k} > {Em}_{c 2 , k} \frac{{Em}_{c 2 , k}}{{α}_{9 , F} ( {Em}_{2 , k} - {Em}_{c 2 , k} ) + {α}_{10 , F} {Em}_{c 2 , k}} , if \{ {Em}_{2 , k} = {Em}_{c 2 , k} , 1 , {α}_{9 , F} \frac{{Em}_{c 2 , k} - {Em}_{2 , k}}{{Em}_{2 , k}} + {α}_{10 , F} \} \} \times \frac{( {α}_{3 , F} {ST}_{j} + {α}_{4 , F} )}{( {α}_{1 , F} {Di}_{k} + {α}_{2 , F} ) ( {α}_{5 , F} {SH}_{j} + {α}_{6 , F} ) ( {α}_{7 , F} {SF}_{j} + {α}_{8 , F} )} \qquad ( 2 )$$

where if represents a conditional function, FT_{k,j} represents cross-sectional temperature data of the furnace at the k^{th} second preset point at the j^{th} time point in the detection cycle, Em_{2,k} represents a second emissivity at the k^{th} second preset point, Em_{c2,k} represents a second camera emissivity of a single infrared probe at a k^{th} second preset position, STⱼ represents temperature information of the periphery of the furnace at the j^{th} time point in the detection cycle, SHⱼ represents humidity information of the periphery of the furnace at the j^{th} time point in the detection cycle, SFⱼ represents wind force information of the periphery of the furnace at the j^{th} time point in the detection cycle, Diₖ represents a second distance between the k^{th} second preset position and the k^{th} second preset point, α_{1,F} represents a solved value of the α₁, α_{2,F} represents a solved value of the α_{2,F} represents a solved value of the α₃, α_{4,F} represents a solved value of the α₄, α_{5,F} represents a solved value of the α₅, α_{6,F} represents a solved value of the α₆, α_{7,F} represents a solved value of the α₇, α_{8,F} represents a solved value of the α₈, α_{9,F} represents a solved value of the α₉, and α_{10,F} represents a solved value of the α₁₀.

According to an embodiment of the present disclosure, the second camera emissivities, the second emissivities, the second distance, the environmental information, and the cross-sectional temperature data of the furnace can be substituted into the error relationship function to obtain the formula (2). In this way, actual cross-sectional temperature data of the furnace at the j^{th} time point in the detection cycle is obtained, so as to further determine actual cross-sectional temperature data of the furnace at each time point in the detection cycle.

In this way, the actual cross-sectional temperature data of the furnace can be determined based on the second camera emissivities, the second emissivities, the second distance, the environmental information, the cross-sectional temperature data of the furnace, and the error relationship function. This can improve accuracy and objectivity of the actual cross-sectional temperature data of the furnace, providing a data foundation for subsequent detection of the cross-sectional temperature field of the furnace.

According to an embodiment of the present disclosure, that the detection score of the cross-sectional temperature field of the furnace is determined based on the actual cross-sectional temperature data of the furnace and the coordinate information includes the following substeps:

A temperature distribution function is determined based on the actual cross-sectional temperature data of the furnace and the coordinate information.

Actual cross-sectional temperature data of the furnace at a k^{th} second preset point is fitted with a time point in the detection cycle, and an actual temperature function of an actual cross-sectional temperature of the furnace at the k^{th} second preset point in the detection cycle is obtained.

An actual temperature derivative function is obtained based on the actual temperature function.

Actual temperature change rates at the k^{th} second preset point at the plurality of time points in the detection cycle are determined based on the actual temperature derivative function.

A temperature change rate distribution function is determined based on the actual temperature change rates and the coordinate information.

A first standard deviation is determined based on the actual cross-sectional temperature data of the furnace.

A second standard deviation is determined based on the actual temperature change rates.

The detection score of the cross-sectional temperature field of the furnace is determined based on the first standard deviation, the second standard deviation, the temperature change rate distribution function, and the temperature distribution function.

For example, the temperature distribution function is determined based on the actual furnace cross-sectional temperature data and the coordinate information at the plurality of second preset points to represent temperature distributions at the plurality of second preset points in the cross-section of the furnace. The actual cross-sectional temperature data of the furnace at the k^{th} second preset point is fitted with the time point in the detection cycle to obtain the actual temperature function used to describe a law that the actual cross-sectional temperature data of the furnace at the k^{th} second preset point in the detection cycle changes over time. A derivative of the actual temperature function is taken to determine the actual temperature derivative function. The time point in the detection cycle is substituted into the actual temperature derivative function to determine the actual temperature change rates at the k^{th} second preset point at the plurality of time points in the detection cycle. The temperature change rate distribution function is determined based on the actual temperature change rates and the coordinate information at the plurality of second preset points. The first standard deviation between actual cross-sectional temperature data of the furnace at the plurality of second preset points at each time point in the detection cycle is calculated. The second standard deviation between actual temperature change rates at the plurality of second preset points at each time point in the detection cycle is calculated. The cross-sectional temperature field of the furnace is detected and analyzed based on the first standard deviation, the second standard deviation, the temperature change rate distribution function and the temperature distribution function to determine the detection score of the cross-sectional temperature field of the furnace.

According to an embodiment of the present disclosure, that the detection score of the cross-sectional temperature field of the furnace is determined based on the first standard deviation, the second standard deviation, the temperature change rate distribution function, and the temperature distribution function includes: the detection score Tfd of the cross-sectional temperature field of the furnace is determined according to a formula (3):

$$Tfd = {θ}_{1} \frac{1}{mK} {\sum }_{j = 1}^{m} {\sum }_{k = 1}^{K} if \{ {Td}_{j} ( {x}_{k} , {y}_{k} ) ∈ [ \frac{{\sum }_{k = 1}^{K} {Td}_{j} ( {x}_{k} , {y}_{k} )}{K} + {β}_{p} {Sd}_{1 , j} , \frac{{\sum }_{k = 1}^{K} {Td}_{j} ( {x}_{k} , {y}_{k} )}{K} - {β}_{p} {Sd}_{1 , j} ] , 1 , 0 \} + {θ}_{2} \frac{1}{mK} {\sum }_{j = 1}^{m} {\sum }_{k = 1}^{K} if \{ {Tr}_{j} ( {x}_{k} , {y}_{k} ) ∈ [ \frac{{\sum }_{k = 1}^{K} {Tr}_{j} ( {x}_{k} , {y}_{k} )}{K} + {β}_{p} {Sd}_{2 , j} , \frac{{\sum }_{k = 1}^{K} {Tr}_{j} ( {x}_{k} , {y}_{k} )}{K} - {β}_{p} {Sd}_{2 , j} ] , 1 , 0 \} - {θ}_{3} \frac{\frac{{\sum }_{j = 1}^{m} {max}_{k ∈ [ 1 , K ]} {Td}_{j} ( {x}_{k} , {y}_{k} )}{m} - {Tg}_{T}}{{Tg}_{T}} \qquad ( 3 )$$

where max represents a maximum value function, βₚ represents a preset multiple, θ₁, θ₂, and θ₃ represent preset weights, if represents a conditional function, (xₖ, yₖ) represents coordinate information of the k^{th} second preset point, Tdⱼ(xₖ, yₖ) represents a function value of the temperature distribution function at the k^{th} second preset point at a j^{th} time point in the detection cycle, Sd_{1,j} represents a first standard deviation at the j^{th} time point in the detection cycle, Trⱼ(xₖ, yₖ) represents a function value of the temperature change rate distribution function at the k^{th} second preset point at the j^{th} time point in the detection cycle, Sd_{2,j} represents a second standard deviation at the j^{th} time point in the detection cycle, Tg_{T} represents a preset temperature threshold, K represents a quantity of the second preset points, k≤K, m represents a quantity of the time points in the detection cycle, j≤m, and k, K, j, and m are all positive integers.

According to an embodiment of the present disclosure, in the formula (3), the following two situations can be expressed in a form of the conditional function. When

$${Td}_{j} ( {x}_{k} , {y}_{k} ) ∈ [ \frac{{\sum }_{k = 1}^{K} {Td}_{j} ( {x}_{k} , {y}_{k} )}{K} + {β}_{p} {Sd}_{1 , j} , \frac{{\sum }_{k = 1}^{K} {Td}_{j} ( {x}_{k} , {y}_{k} )}{K} - {β}_{p} {Sd}_{1 , j} ]$$

is met, it indicates that actual cross-sectional temperature data of the furnace at the k^{th} second preset point in the cross-section of the furnace at the j^{th} time point is within an interval centered by average actual cross-sectional temperature data of the furnace and with a first standard deviation twice the preset multiple as an interval length, and a value of the conditional function is 1. When

$${Td}_{j} ( {x}_{k} , {y}_{k} ) ∈ [ \frac{{\sum }_{k = 1}^{K} {Td}_{j} ( {x}_{k} , {y}_{k} )}{K} + {β}_{p} {Sd}_{1 , j} , \frac{{\sum }_{k = 1}^{K} {Td}_{j} ( {x}_{k} , {y}_{k} )}{K} - {β}_{p} {Sd}_{1 , j} ]$$

is not met, the value of the conditional function is 0. If the actual cross-sectional temperature data of the furnace at the k^{th} second preset point at the j^{th} time point meets the above condition, it indicates that a deviation between the actual cross-sectional temperature data of the furnace and an average value of actual cross-sectional temperature data of the furnace at K second preset points at the j^{th} time point is relatively small. Otherwise, it can be considered that the deviation between the actual cross-sectional temperature data of the furnace and the average value is relatively large.

$$\frac{1}{K} {\sum }_{k = 1}^{K} if \{ {Td}_{j} ( {x}_{k} , {y}_{k} ) ∈ [ \frac{{\sum }_{k = 1}^{K} {Td}_{j} ( {x}_{k} , {y}_{k} )}{K} + {β}_{p} {Sd}_{1 , j} , \frac{{\sum }_{k = 1}^{K} {Td}_{j} ( {x}_{k} , {y}_{k} )}{K} - {β}_{p} {Sd}_{1 , j} ] , 1 , 0 \}$$

represents a ratio of a quantity of second preset points with small deviations between actual cross-sectional temperature data of the furnace and the average value to a total quantity of the second preset points. The larger the ratio, the more uniform a distribution determined for the cross-sectional temperature field of the furnace based on a temperature.

$$\frac{{\sum }_{j = 1}^{m} {\sum }_{k = 1}^{K} if \{ {Td}_{j} ( {x}_{k} , {y}_{k} ) ∈ [ \frac{{\sum }_{k = 1}^{K} {Td}_{j} ( {x}_{k} , {y}_{k} )}{K} + {β}_{p} {Sd}_{1 , j} , \frac{{\sum }_{k = 1}^{K} {Td}_{j} ( {x}_{k} , {y}_{k} )}{K} - {β}_{p} {Sd}_{1 , j} ] , 1 , 0 \}}{mK}$$

represents an operation of taking the average value based on a quantity of the time points in the detection cycle. The larger the ratio, the more uniform an overall distribution determined for the cross-sectional temperature field of the furnace based on the temperature in the detection cycle.

According to an embodiment of the present disclosure, in the formula (3), the following two situations can be expressed in the form of the conditional function. When

$${Tr}_{j} ( {x}_{k} , {y}_{k} ) ∈ [ \frac{{\sum }_{k = 1}^{K} {Tr}_{j} ( {x}_{k} , {y}_{k} )}{K} + {β}_{p} {Sd}_{2 , j} , \frac{{\sum }_{k = 1}^{K} {Tr}_{j} ( {x}_{k} , {y}_{k} )}{K} - {β}_{p} {Sd}_{2 , j} ]$$

is met, it indicates that an actual temperature change rate at the k^{th} second preset point in the cross-section of the furnace at the j^{th} time point is within an interval centered by an average actual temperature change rate and with a second standard deviation twice the preset multiple as an interval length, and the value of the conditional function is 1. When

$${Tr}_{j} ( {x}_{k} , {y}_{k} ) ∈ [ \frac{{\sum }_{k = 1}^{K} {Tr}_{j} ( {x}_{k} , {y}_{k} )}{K} + {β}_{p} {Sd}_{2 , j} , \frac{{\sum }_{k = 1}^{K} {Tr}_{j} ( {x}_{k} , {y}_{k} )}{K} - {β}_{p} {Sd}_{2 , j} ]$$

is not met, the value of the conditional function is 0. If the actual temperature change rate at the k^{th} second preset point at the j^{th} time point meets the above condition, it indicates that a deviation between the actual temperature change rate and an average value of actual temperature change rates at the K second preset points at the j^{th} time point is relatively small. Otherwise, it can be considered that the deviation between the actual temperature change rate and the average value is relatively large.

$$\frac{1}{K} {\sum }_{k = 1}^{K} if \{ {Tr}_{j} ( {x}_{k} , {y}_{k} ) ∈ [ \frac{{\sum }_{k = 1}^{K} {Tr}_{j} ( {x}_{k} , {y}_{k} )}{K} + {β}_{p} {Sd}_{2 , j} , \frac{{\sum }_{k = 1}^{K} {Tr}_{j} ( {x}_{k} , {y}_{k} )}{K} - {β}_{p} {Sd}_{2 , j} ] , 1 , 0 \}$$

represents a ratio of a quantity of second preset points with small deviations between actual temperature change rates and the average value to the total quantity of the second preset points. The larger the ratio, the more uniform a distribution determined for the cross-sectional temperature field of the furnace based on a temperature change rate.

$$\frac{\begin{matrix}{\sum }_{j = 1}^{m} {\sum }_{k = 1}^{K} if \{ {Tr}_{j} ( {x}_{k} , {y}_{k} ) ∈ [ \frac{{\sum }_{k = 1}^{K} {Tr}_{j} ( {x}_{k} , {y}_{k} )}{K} + \\ {β}_{p} {Sd}_{2 , j} , \frac{{\sum }_{k = 1}^{K} {Tr}_{j} ( {x}_{k} , {y}_{k} )}{K} - {β}_{p} {Sd}_{2 , j} ] , 1 , 0 \}\end{matrix}}{mK}$$

represents an operation of taking the average value based on the quantity of the time points in the detection cycle. The larger the ratio, the more uniform an overall distribution determined for the cross-sectional temperature field of the furnace based on the temperature change rate in the detection cycle.

According to an embodiment of the present disclosure, max_{k∈[1,K]}Tdⱼ(xₖ, yₖ) represents an operation of taking a maximum value of the actual cross-sectional temperature data of the furnace at the K second preset points at the j^{th} time point in the detection cycle. The above operation of taking the maximum value can be used to determine a situation with a highest temperature in the cross-section of the furnace. An excessive temperature may cause slagging at places such as a water-cooled wall of the furnace, affecting safe operation of a boiler.

$$\frac{{\sum }_{j = 1}^{m} {max}_{k ∈ [ 1 , K ]} {Td}_{j} ( {x}_{k} , {y}_{k} )}{m}$$

represents an operation of taking an average value based on the quantity of the time points in the detection cycle, indicating a maximum average temperature in the detection cycle.

$$\frac{\frac{{\sum }_{j = 1}^{m} {max}_{k ∈ [ 1 , K ]} {Td}_{j} ( {x}_{k} , {y}_{k} )}{m} - {Tg}_{T}}{{Tg}_{T}}$$

represents a relative difference between an average value of the maximum value of the actual cross-sectional temperature data of the furnace at the K second preset points in the detection cycle and the preset temperature threshold. The larger the ratio, the greater a possibility of an excessive temperature in the cross-section of the furnace in the detection cycle and the greater a possibility of a safety risk.

In this way, the detection score of the cross-sectional temperature field of the furnace can be calculated based on the first standard deviation, the second standard deviation, the temperature change rate distribution function, and the temperature distribution function. In a calculation process, the cross-sectional temperature field of the furnace can be separately detected and analyzed from a plurality of aspects, including the overall distribution that is of the cross-sectional temperature field of the furnace and determined based on the temperature, the overall distribution that is of the cross-sectional temperature field of the furnace and determined based on the temperature change rate, and whether there is a high-temperature condition in the cross-section of the furnace. This enhances comprehensiveness and accuracy of the detection score of the cross-sectional temperature field of the furnace.

According to an embodiment of the present disclosure, in the step S107, the detection report of the cross-sectional temperature field of the furnace is generated based on the detection score of the cross-sectional temperature field of the furnace.

For example, if the detection score of the cross-sectional temperature field of the furnace is less than a specified detection score threshold of the cross-sectional temperature field of the furnace, it indicates that there is uneven combustion or a locally excessively high temperature in the furnace.

According to the method for detecting a cross-sectional temperature field of a furnace with a single infrared probe in the embodiments of the present disclosure, a relationship between a temperature detection error and each of temperature information, humidity information, a detection distance, and wind force information can be accurately analyzed. Furthermore, based on the relationship, accuracy of detecting the cross-sectional temperature field of the furnace is improved. The cross-sectional temperature field of the furnace is detected and analyzed based on cross-sectional temperature data of the furnace and coordinate information at various second preset points, thereby enhancing accuracy of a detection result of the cross-sectional temperature field of the furnace. An error relationship function can be determined based on a first emissivity, a first camera emissivity, a first distance, a first detected temperature, a second detected temperature, and environmental information, such that a relationship between the temperature detection error and each of an environmental factor, a camera emissivity, and the detection distance is accurately described, thereby improving accuracy of the error relationship function. Actual cross-sectional temperature data of the furnace is determined based on second camera emissivities, second emissivities, a second distance, the environmental information, the cross-sectional temperature data of the furnace, and the error relationship function. This can improve accuracy and objectivity of the actual cross-sectional temperature data of the furnace, providing a data foundation for subsequent detection of the cross-sectional temperature field of the furnace. A detection score of the cross-sectional temperature field of the furnace can be calculated based on a first standard deviation, a second standard deviation, a temperature change rate distribution function, and a temperature distribution function. In a calculation process, the cross-sectional temperature field of the furnace can be separately detected and analyzed from a plurality of aspects, including an overall distribution that is of the cross-sectional temperature field of the furnace and determined based on a temperature, an overall distribution that is of the cross-sectional temperature field of the furnace and determined based on a temperature change rate, and whether there is a high-temperature condition in a cross-section of the furnace. This enhances comprehensiveness and accuracy of the detection score of the cross-sectional temperature field of the furnace.

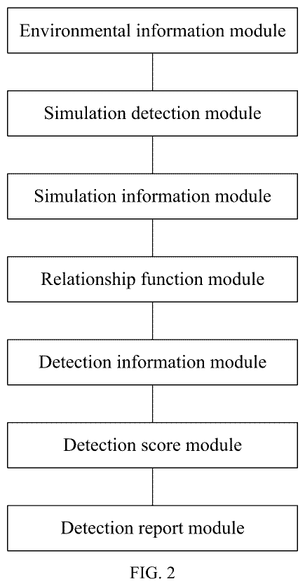

FIG. 2 is a schematic diagram of a system for detecting a cross-sectional temperature field of a furnace with a single infrared probe according to an embodiment of the present disclosure. The system includes:
an environmental information module configured to acquire environmental information of a preset simulated detection space and a periphery of the furnace through a combination of sensors disposed around the furnace, where the environmental information includes temperature information, humidity information, and wind force information;
a simulation detection module configured to: at a plurality of time points in a simulated detection cycle, collect a first detected temperature at a first preset point by using a single infrared probe disposed at a first preset position, and determine a first distance between the first preset position and the first preset point;
a simulation information module configured to collect a second detected temperature at the first preset point by using a temperature sensor disposed at the first preset point;
a relationship function module configured to determine an error relationship function based on the first distance, the first detected temperature, the second detected temperature, and the environmental information;
a detection information module configured to: at the plurality of time points in the detection cycle, collect cross-sectional temperature data of the furnace at a plurality of second preset points in a cross-section of the furnace by using second single infrared probes disposed at a plurality of second preset positions in the furnace, and determine coordinate information of the plurality of second preset points in a furnace coordinate system, where the furnace coordinate system is a coordinate system established based on a centroid of the cross-section of the furnace;
a detection score module configured to determine a detection score of the cross-sectional temperature field of the furnace based on the cross-sectional temperature data of the furnace and the coordinate information; and
a detection report module configured to generate a detection report of the cross-sectional temperature field of the furnace based on the detection score of the cross-sectional temperature field of the furnace.

It should be understood by those skilled in the art that the embodiments of the present disclosure in the above description and the accompanying drawings are merely illustrative and are not intended to limit the present disclosure. The objective of the present disclosure has been fully and effectively achieved. The functions and structural principles of the present disclosure have been demonstrated and described in the embodiments, and any variations or modifications may be made to the implementations of the present disclosure without departing from the aforementioned principles.

What is claimed is:

1. A method for detecting a cross-sectional temperature field of a furnace with a single infrared probe, comprising:
acquiring environmental information of a preset simulated detection space and a periphery of the furnace through a combination of sensors disposed around the furnace, wherein the environmental information comprises temperature information, humidity information, and wind force information;
at a plurality of time points in a simulated detection cycle, collecting a first detected temperature at a first preset point by using a single infrared probe disposed at a first preset position, and determining a first distance between the first preset position and the first preset point;
collecting a second detected temperature at the first preset point by using a temperature sensor disposed at the first preset point;
determining an error relationship function based on the first distance, the first detected temperature, the second detected temperature, and the environmental information;
at the plurality of time points in the detection cycle, collecting cross-sectional temperature data of the furnace at a plurality of second preset points in a cross-section of the furnace by using second single infrared probes disposed at a plurality of second preset positions in the furnace, and determining coordinate information of the plurality of second preset points in a furnace coordinate system, wherein the furnace coordinate system is a coordinate system established based on a centroid of the cross-section of the furnace;
determining a detection score of the cross-sectional temperature field of the furnace based on the cross-sectional temperature data of the furnace and the coordinate information; and
generating a detection report of the cross-sectional temperature field of the furnace based on the detection score of the cross-sectional temperature field of the furnace;
wherein the determining the error relationship function based on the first distance, the first detected temperature, the second detected temperature, and the environmental information comprises:
acquiring a first emissivity of a material at the first preset point;
acquiring a first camera emissivity of the single infrared probe at the first preset position; and
determining the error relationship function based on the first emissivity, the first camera emissivity, the first distance, the first detected temperature, the second detected temperature, and the environmental information;
wherein the determining the detection score of the cross-sectional temperature field of the furnace based on the cross-sectional temperature data of the furnace and the coordinate information comprises:
acquiring camera coordinate information of the plurality of second preset positions in the furnace coordinate system;
determining a second distance based on the camera coordinate information and the coordinate information;
acquiring second camera emissivities of the second single infrared probes disposed at the plurality of second preset positions in the furnace;
acquiring second emissivities of materials at the plurality of second preset points;
determining actual cross-sectional temperature data of the furnace based on the second camera emissivities, the second emissivities, the second distance, the environmental information, the cross-sectional temperature data of the furnace, and the error relationship function; and
determining the detection score of the cross-sectional temperature field of the furnace based on the actual cross-sectional temperature data of the furnace and the coordinate information.

2. The method for detecting the cross-sectional temperature field of the furnace with the single infrared probe according to claim 1, wherein the determining the error relationship function based on the first emissivity, the first camera emissivity, the first distance, the first detected temperature, the second detected temperature, and the environmental information comprises:
according to a formula
$${DT}_{1 , i} - {DT}_{2 , i} = if \{ {Em}_{1} > {Em}_{c 1} , \frac{{Em}_{c 1}}{{α}_{9} ( {Em}_{1} - {Em}_{c 1} ) + {α}_{10} {Em}_{c 1}} , if \{ {Em}_{1} = {Em}_{c 1} , 1 , {α}_{9} \frac{{Em}_{c 1} - {Em}_{1}}{{Em}_{1}} + {α}_{10} \} \} \times \frac{( {α}_{3} {ET}_{i} + {α}_{4} )}{( {α}_{1} {Di}_{1 , i} + {α}_{2} ) ( {α}_{5} {EH}_{i} + {α}_{6} ) ( {α}_{7} {EF}_{i} + {α}_{8} )} ,$$
determining a to-be-fitted equation of the error relationship function, wherein if represents a conditional function, DT_{1,i} represents a first detected temperature at the first preset point at an i^{th} time point in the simulated detection cycle, DT_{2,i} represents a second detected temperature at the first preset point at the i^{th} time point in the simulated detection cycle, Em₁ represents the first emissivity of the material at the first preset point, Em_{c1} represents the first camera emissivity of the single infrared probe at the first preset position, Di_{1,i} represents a first distance between the first preset position and the first preset point at the i^{th} time point in the simulated detection cycle, ETᵢ represents temperature information of the preset simulated detection space at the i^{th} time point in the simulated detection cycle, EHᵢ represents humidity information of the preset simulated detection space at the i^{th} time point in the simulated detection cycle, EFᵢ represents wind force information of the preset simulated detection space at the i^{th} time point in the simulated detection cycle, and α₁, α₂, α₃, α₄, α₅, α₆, α₇, α₈, α₉, and α₁₀ represent to-be-fitted coefficients;
solving the to-be-fitted coefficients based on the first emissivity, the first camera emissivity, the first distance, the first detected temperature, the second detected temperature, and the environmental information, and obtaining solved values of the to-be-fitted coefficients; and
determining the error relationship function based on the solved values of the to-be-fitted coefficients and the to-be-fitted equation.

3. The method for detecting the cross-sectional temperature field of the furnace with the single infrared probe according to claim 1, wherein the determining the actual cross-sectional temperature data of the furnace based on the second camera emissivities, the second emissivities, the second distance, the environmental information, the cross-sectional temperature data of the furnace, and the error relationship function comprises:
according to a formula
$${FT}_{k , j} - {FFT}_{k , j} = if \{ {Em}_{2 , k} > {Em}_{c 2 , k} \frac{{Em}_{c 2 , k}}{{α}_{9 , F} ( {Em}_{2 , k} - {Em}_{c 2 , k} ) + {α}_{10 , F} {Em}_{c 2 , k}} , if \{ {Em}_{2 , k} = {Em}_{c 2 , k} , 1 , {α}_{9 , F} \frac{{Em}_{c 2 , k} - {Em}_{2 , k}}{{Em}_{2 , k}} + {α}_{10 , F} \} \} \times \frac{( {α}_{3 , F} {ST}_{j} + {α}_{4 , F} )}{( {α}_{1 , F} {Di}_{k} + {α}_{2 , F} ) ( {α}_{5 , F} {SH}_{j} + {α}_{6 , F} ) ( {α}_{7 , F} {SF}_{j} + {α}_{8 , F} )} ,$$
determining actual cross-sectional temperature data FFT_{k,j} of the furnace at a k^{th} second preset point at a j^{th} time point in the detection cycle, wherein if represents a conditional function, FT_{k,j} represents cross-sectional temperature data of the furnace at the k^{th} second preset point at the j^{th} time point in the detection cycle, Em_{2,k} represents a second emissivity at the k^{th} second preset point, Em_{c2,k} represents a second camera emissivity of a single infrared probe at a k^{th} second preset position, STⱼ represents temperature information of the periphery of the furnace at the j^{th} time point in the detection cycle, SHⱼ represents humidity information of the periphery of the furnace at the j^{th} time point in the detection cycle, SFⱼ represents wind force information of the periphery of the furnace at the j^{th} time point in the detection cycle, Diₖ represents a second distance between the k^{th} second preset position and the k^{th} second preset point, α_{1,F} represents a solved value of the α₁, α_{2,F} represents a solved value of the α₂, α_{3,F} represents a solved value of the α₃, α_{4,F} represents a solved value of the α₄, α_{5,F} represents a solved value of the α₅, α_{6,F} represents a solved value of the α₆, α_{7,F} represents a solved value of the α₇, α_{8,F} represents a solved value of the α₈, α_{9,F} represents a solved value of the α₉, and α_{10,F} represents a solved value of the α₁₀.

4. The method for detecting the cross-sectional temperature field of the furnace with the single infrared probe according to claim 1, wherein the determining the detection score of the cross-sectional temperature field of the furnace based on the actual cross-sectional temperature data of the furnace and the coordinate information comprises:
determining a temperature distribution function based on the actual cross-sectional temperature data of the furnace and the coordinate information;
fitting actual cross-sectional temperature data of the furnace at a k^{th} second preset point with a time point in the detection cycle, and obtaining an actual temperature function of an actual cross-sectional temperature of the furnace at the k^{th} second preset point in the detection cycle;
obtaining an actual temperature derivative function based on the actual temperature function;
determining actual temperature change rates at the k^{th} second preset point at the plurality of time points in the detection cycle based on the actual temperature derivative function;
determining a temperature change rate distribution function based on the actual temperature change rates and the coordinate information;
determining a first standard deviation based on the actual cross-sectional temperature data of the furnace;
determining a second standard deviation based on the actual temperature change rates; and
determining the detection score of the cross-sectional temperature field of the furnace based on the first standard deviation, the second standard deviation, the temperature change rate distribution function, and the temperature distribution function.

5. The method for detecting the cross-sectional temperature field of the furnace with the single infrared probe according to claim 4, wherein the determining the detection score of the cross-sectional temperature field of the furnace based on the first standard deviation, the second standard deviation, the temperature change rate distribution function, and the temperature distribution function comprises:
according to a formula
$$Tfd = {θ}_{1} \frac{1}{mK} {\sum }_{j = 1}^{m} {\sum }_{k = 1}^{K} if \{ {Td}_{j} ( {x}_{k} , {y}_{k} ) ∈ [ \frac{{\sum }_{k = 1}^{K} {Td}_{j} ( {x}_{k} , {y}_{k} )}{K} + {β}_{p} {Sd}_{1 , j} , \frac{{\sum }_{k = 1}^{K} {Td}_{j} ( {x}_{k} , {y}_{k} )}{K} - {β}_{p} {Sd}_{1 , j} ] , 1 , 0 \} + {θ}_{2} \frac{1}{mK} {\sum }_{j = 1}^{m} {\sum }_{k = 1}^{K} if \{ {T r}_{j} ( {x}_{k} , {y}_{k} ) ∈ [ \frac{{\sum }_{k = 1}^{K} {Tr}_{j} ( {x}_{k} , {y}_{k} )}{K} + {β}_{p} {Sd}_{2 , j} , \frac{{\sum }_{k = 1}^{K} {Tr}_{j} ( {x}_{k} , {y}_{k} )}{K} - {β}_{p} {Sd}_{2 , j} ] , 1 , 0 \} - {θ}_{3} \frac{\frac{{\sum }_{j = 1}^{m} {max}_{k ∈ [ 1 , K ]} {Td}_{j} ( {x}_{k} , {y}_{k} )}{m} - {Tg}_{T}}{{Tg}_{T}} ,$$
determining the detection score Tfd of the cross-sectional temperature field of the furnace, wherein max represents a maximum value function, βₚ represents a preset multiple, θ₁, θ₂, and θ₃ represent preset weights, if represents a conditional function, (xₖ, yₖ) represents coordinate information of the k^{th} second preset point, Tdⱼ(xₖ, yₖ) represents a function value of the temperature distribution function at the k^{th} second preset point at a j^{th} time point in the detection cycle, Sd_{1,j} represents a first standard deviation at the j^{th} time point in the detection cycle, Trⱼ(xₖ, yₖ) represents a function value of the temperature change rate distribution function at the k^{th} second preset point at the j^{th} time point in the detection cycle, Sd_{2,j} represents a second standard deviation at the j^{th} time point in the detection cycle, Tg_{T} represents a preset temperature threshold, K represents a quantity of the second preset points, k≤K, m represents a quantity of the time points in the detection cycle, j m, and k, K, j, and m are all positive integers.

6. A system for detecting a cross-sectional temperature field of a furnace with a single infrared probe, configured to implement the method according to claim 1, comprising:
an environmental information module configured to acquire the environmental information of the preset simulated detection space and the periphery of the furnace through the combination of the sensors disposed around the furnace, wherein the environmental information comprises the temperature information, the humidity information, and the wind force information;
a simulation detection module configured to: at the plurality of time points in the simulated detection cycle, collect the first detected temperature at the first preset point by using the single infrared probe disposed at the first preset position, and determine the first distance between the first preset position and the first preset point;
a simulation information module configured to collect the second detected temperature at the first preset point by using the temperature sensor disposed at the first preset point;
a relationship function module configured to determine the error relationship function based on the first distance, the first detected temperature, the second detected temperature, and the environmental information;
a detection information module configured to: at the plurality of time points in the detection cycle, collect the cross-sectional temperature data of the furnace at the plurality of second preset points in the cross-section of the furnace by using the second single infrared probes disposed at the plurality of second preset positions in the furnace, and determine the coordinate information of the plurality of second preset points in the furnace coordinate system, wherein the furnace coordinate system is the coordinate system established based on the centroid of the cross-section of the furnace;
a detection score module configured to determine the detection score of the cross-sectional temperature field of the furnace based on the cross-sectional temperature data of the furnace and the coordinate information; and
a detection report module configured to generate the detection report of the cross-sectional temperature field of the furnace based on the detection score of the cross-sectional temperature field of the furnace.

7. The system according to claim 6, wherein in the method, the determining the error relationship function based on the first emissivity, the first camera emissivity, the first distance, the first detected temperature, the second detected temperature, and the environmental information comprises:
according to a formula
$${DT}_{1 , i} - {DT}_{2 , i} = if \{ {Em}_{1} > {Em}_{c 1} , \frac{{Em}_{c 1}}{{α}_{9} ( {Em}_{1} - {Em}_{c 1} ) + {α}_{10} {Em}_{c 1}} , if \{ {Em}_{1} = {Em}_{c 1} , 1 , {α}_{9} \frac{{Em}_{c 1} - {Em}_{1}}{{Em}_{1}} + {α}_{10} \} \} \times \frac{( {α}_{3} {ET}_{i} + {α}_{4} )}{( {α}_{1} {Di}_{1 , i} + {α}_{2} ) ( {α}_{5} {EH}_{i} + {α}_{6} ) ( {α}_{7} {EF}_{i} + {α}_{8} )} ,$$
determining a to-be-fitted equation of the error relationship function, wherein if represents a conditional function, DT_{1,i} represents a first detected temperature at the first preset point at an i^{th} time point in the simulated detection cycle, DT_{2,i} represents a second detected temperature at the first preset point at the i^{th} time point in the simulated detection cycle, Em₁ represents the first emissivity of the material at the first preset point, Em_{c1} represents the first camera emissivity of the single infrared probe at the first preset position, Di_{1,i} represents a first distance between the first preset position and the first preset point at the i^{th} time point in the simulated detection cycle, ETᵢ represents temperature information of the preset simulated detection space at the i^{th} time point in the simulated detection cycle, EHᵢ represents humidity information of the preset simulated detection space at the i^{th} time point in the simulated detection cycle, EFᵢ represents wind force information of the preset simulated detection space at the i^{th} time point in the simulated detection cycle, and α₁, α₂, α₃, α₄, α₅, α₆, α₇, α₈, α₉, and α₁₀ represent to-be-fitted coefficients;
solving the to-be-fitted coefficients based on the first emissivity, the first camera emissivity, the first distance, the first detected temperature, the second detected temperature, and the environmental information, and obtaining solved values of the to-be-fitted coefficients; and
determining the error relationship function based on the solved values of the to-be-fitted coefficients and the to-be-fitted equation.

8. The system according to claim 6, wherein in the method, the determining the actual cross-sectional temperature data of the furnace based on the second camera emissivities, the second emissivities, the second distance, the environmental information, the cross-sectional temperature data of the furnace, and the error relationship function comprises:
according to a formula
$${FT}_{k , j} - {FFT}_{k , j} = if \{ {Em}_{2 , k} > {Em}_{c 2 , k} , \frac{{Em}_{c 2 , k}}{{α}_{9 , F} ( {Em}_{2 , k} - {Em}_{c 2 , k} ) + {α}_{10 , F} {Em}_{c 2 , k}} , if \{ {Em}_{2 , k} = {Em}_{c 2 , k} , 1 , {α}_{9 , k} \frac{{Em}_{c 2 , k} - {Em}_{2 , k}}{{Em}_{2 , k}} + {α}_{10 , F} \} \} \times \frac{( {α}_{3 , F} {ST}_{j} + {α}_{4 , F} )}{( {α}_{1 , F} {Di}_{k} + {α}_{2 , F} ) ( {α}_{5 , F} {SH}_{j} + {α}_{6 , F} ) ( {α}_{7 , F} {SF}_{j} + {α}_{8 , F} )} ,$$
determining actual cross-sectional temperature data FFT_{k,j} of the furnace at a k^{th} second preset point at a j^{th} time point in the detection cycle, wherein if represents a conditional function, FT_{k,j} represents cross-sectional temperature data of the furnace at the k^{th} second preset point at the j^{th} time point in the detection cycle, Em_{2,k} represents a second emissivity at the k^{th} second preset point, Em_{c2,k} represents a second camera emissivity of a single infrared probe at a k^{th} second preset position, STⱼ represents temperature information of the periphery of the furnace at the j^{th} time point in the detection cycle, SHⱼ represents humidity information of the periphery of the furnace at the j^{th} time point in the detection cycle, SFⱼ represents wind force information of the periphery of the furnace at the j^{th} time point in the detection cycle, Diₖ represents a second distance between the k^{th} second preset position and the k^{th} second preset point, α_{1,F} represents a solved value of the α₁, α_{2,F} represents a solved value of the α₂, α_{3,F} represents a solved value of the α₃, α_{4,F} represents a solved value of the α₄, α_{5,F} represents a solved value of the α₅, α_{6,F} represents a solved value of the α₆, α_{7,F} represents a solved value of the α₇, α_{8,F} represents a solved value of the α₈, α_{9,F} represents a solved value of the α₉, and α_{10,F} represents a solved value of the α₁₀.

9. The system according to claim 6, wherein in the method, the determining the detection score of the cross-sectional temperature field of the furnace based on the actual cross-sectional temperature data of the furnace and the coordinate information comprises:
determining a temperature distribution function based on the actual cross-sectional temperature data of the furnace and the coordinate information;
fitting actual cross-sectional temperature data of the furnace at a k^{th} second preset point with a time point in the detection cycle, and obtaining an actual temperature function of an actual cross-sectional temperature of the furnace at the k^{th} second preset point in the detection cycle;
obtaining an actual temperature derivative function based on the actual temperature function;
determining actual temperature change rates at the k^{th} second preset point at the plurality of time points in the detection cycle based on the actual temperature derivative function;
determining a temperature change rate distribution function based on the actual temperature change rates and the coordinate information;
determining a first standard deviation based on the actual cross-sectional temperature data of the furnace;
determining a second standard deviation based on the actual temperature change rates; and
determining the detection score of the cross-sectional temperature field of the furnace based on the first standard deviation, the second standard deviation, the temperature change rate distribution function, and the temperature distribution function.

10. The system according to claim 9, wherein in the method, the determining the detection score of the cross-sectional temperature field of the furnace based on the first standard deviation, the second standard deviation, the temperature change rate distribution function, and the temperature distribution function comprises:
according to a formula
$$Tfd = {θ}_{1} \frac{1}{mK} {\sum }_{j = 1}^{m} {\sum }_{k = 1}^{K} if \{ {Td}_{j} ( {x}_{k} , {y}_{k} ) ∈ [ \frac{{\sum }_{k = 1}^{K} {Td}_{j} ( {x}_{k} , {y}_{k} )}{K} + {β}_{p} {Sd}_{1 , j} , \frac{{\sum }_{k = 1}^{K} {Td}_{j} ( {x}_{k} , {y}_{k} )}{K} - {β}_{p} {Sd}_{1 , j} ] , 1 , 0 \} + {θ}_{2} \frac{1}{mK} {\sum }_{j = 1}^{m} {\sum }_{k = 1}^{K} if \{ {T r}_{j} ( {x}_{k} , {y}_{k} ) ∈ [ \frac{{\sum }_{k = 1}^{K} {Tr}_{j} ( {x}_{k} , {y}_{k} )}{K} + {β}_{p} {Sd}_{2 , j} , \frac{{\sum }_{k = 1}^{K} {Tr}_{j} ( {x}_{k} , {y}_{k} )}{K} - {β}_{p} {Sd}_{2 , j} ] , 1 , 0 \} - {θ}_{3} \frac{\frac{{\sum }_{j = 1}^{m} {max}_{k ∈ [ 1 , K ]} {Td}_{j} ( {x}_{k} , {y}_{k} )}{m} - {Tg}_{T}}{{Tg}_{T}} ,$$
determining the detection score Tfd of the cross-sectional temperature field of the furnace, wherein max represents a maximum value function, βₚ represents a preset multiple, θ₁, θ₂, and θ₃ represent preset weights, if represents a conditional function, (xₖ, yₖ) represents coordinate information of the k^{th} second preset point, Tdⱼ(xₖ, yₖ) represents a function value of the temperature distribution function at the k^{th} second preset point at a j^{th} time point in the detection cycle, Sd_{1,j} represents a first standard deviation at the j^{th} time point in the detection cycle, Trⱼ(xₖ, yₖ) represents a function value of the temperature change rate distribution function at the k^{th} second preset point at the j^{th} time point in the detection cycle, Sd_{2,j} represents a second standard deviation at the j^{th} time point in the detection cycle, Tg_{T} represents a preset temperature threshold, K represents a quantity of the second preset points, k≤K, m represents a quantity of the time points in the detection cycle, j≤m, and k, K, j, and m are all positive integers.
